(19) United States
(12) Patent Application Publication
(10) Pub. No.: US 2024/0099347 A1
(43) Pub. Date: Mar. 28, 2024

(54) COMPOSITION

(71) Applicant: J-OIL MILLS, INC., Tokyo (JP)

(72) Inventors: Junko ARAI, Tokyo (JP); Shunsuke MATSUMOTO, Tokyo (JP)

(21) Appl. No.: 18/275,361

(22) PCT Filed: Feb. 25, 2022
(86) PCT No.: PCT/JP2022/007895

§ 371 Date: Aug. 1, 2023

(30) Foreign Application Priority Data
Feb. 26, 2021 (JP) 2021-029971

(51) Int. Cl. A23L 29/262; A23L 29/212; A23L 29/269

(52) U.S. Cl. CPC A23L 29/262; A23L 29/212; A23L 29/271

(57) ABSTRACT

A composition having an egg white substitute function, the composition including a polysaccharide thickener, and a starch, in which the polysaccharide thickener is one kind or two or more kinds selected from the group consisting of methyl cellulose, mannan, and curdlan, and the starch is one or two kinds selected from the group consisting of a distarch phosphate and a pea starch.

### TECHNICAL FIELD

The present invention relates to a composition, a food, a method for producing a food, and a method for imparting at least one of a binding property, an elasticity, and a deflating reduction function to a food.

### BACKGROUND ART

Heretofore, egg whites have been widely used in various processed foods such as processed meat foods, processed meat-like foods, processed sea foods, bakery foods, chilled desserts, and noodles to improve a texture, quality, and the like of the foods. Among them, in the processed meat foods, the processed meat-like foods, and the processed sea foods, the egg whites are normally used to improve the elasticity of the foods to enhance the texture or to bind ingredients to each other. However, there are concerns such as eggs being allergenic, soaring prices of egg whites, unstable supply, and the like.

In addition, in recent years, vegan foods that do not consume animal products have begun to spread due to growing interest in health and environmental problems. The vegan foods are mainly made of protein ingredients using soybean as a main component, and it is important to bind the protein ingredients to each other in terms of product design. However, since an egg white is an animal-derived raw material, it cannot be used in the production of the vegan foods. Therefore, various studies have been made on egg white substitutes.

For example, Patent Document 1 discloses that, when swelling suppression starch and wheat protein are added to noodles, an egg white-like texture can be imparted to the noodles, and thus, these can be used as an egg white substitute. In addition, Patent Document 2 discloses that a coagulable egg white-like composition containing a thermocoagulable protein and starch can be used as a coagulated egg white substitute having a texture similar to that of an egg white portion of a boiled egg.

### RELATED DOCUMENT

### Patent Document

[Patent Document 1] Japanese Unexamined Patent Publication No. 2016-67336
[Patent Document 2] Japanese Unexamined Patent Publication No. 2004-147536

### SUMMARY OF THE INVENTION

### Technical Problem

However, egg white substitutes reported in the related art have room for improvement in terms of imparting a more preferable egg white substitute function. For example, there are not sufficient reports on imparting an egg white-like binding property or elasticity to foods such as processed meat foods, processed meat-like foods, and processed sea foods, and therefore further development of the technology is required.

Thus, the present invention provides an egg white substitute.

### Solution to Problem

As a result of intensive studies, the present inventors have found that a composition containing a polysaccharide thickener and one or two kinds of a starch selected from the group consisting of a distarch phosphate and a pea starch can be a composition having an egg white substitute function, for example, excellent egg white-like binding property and elasticity can be imparted to a food, and for example, a deflating reduction function can be imparted to a food, and the present invention is completed.

That is, according to the present invention, a composition, there are provided a food, a method for producing a food, and a method for imparting at least one of a binding property, an elasticity, and a deflating reduction function to a food described below.

[1] A composition having an egg white substitute function, the composition including a polysaccharide thickener, and a starch,
in which the polysaccharide thickener is one kind or two or more kinds selected from the group consisting of methyl cellulose, mannan, and curdlan, and
the starch is one or two kinds selected from the group consisting of a distarch phosphate and a pea starch.

[2] The composition according to [1], in which the composition is a composition for imparting at least one of a binding property and an elasticity to a food.

[3] The composition according to [1], in which the composition is a composition for imparting a deflating reduction function to a food.

[4] The composition according to any one of [1] to [3], in which the starch includes the distarch phosphate and the pea starch.

[5] The composition according to any one of [1] to [4], in which a content of the starch is 10 or more and 200 or less in terms of a mass ratio to the polysaccharide thickener.

[6] The composition according to any one of [1] to [5], in which the starch includes the distarch phosphate, and
a content of the distarch phosphate is 2 or more and 150 or less in terms of a mass ratio to the polysaccharide thickener.

[7] The composition according to any one of [1] to [6], in which the starch includes the pea starch, and
a content of the pea starch is 2 or more and 150 or less in terms of a mass ratio to the polysaccharide thickener.

[8] A food including the composition according to any one of [1] to [7].

[9] The food according to [8], in which the food is one selected from the group consisting of a processed meat-like food, a processed meat food, a processed sea food, and a bakery food.

[10] A method for producing a food, the method including:
obtaining an aqueous solution or a dispersion by dissolving or dispersing a polysaccharide thickener and a starch in water; and
obtaining a food by preparing a material containing the aqueous solution or the dispersion,
in which the polysaccharide thickener is one kind or two or more kinds selected from the group consisting of methyl cellulose, mannan, and curdlan, and
the starch is one or two kinds selected from the group consisting of a distarch phosphate and a pea starch.

[11] The method for producing a food according to [10], in which the starch includes the distarch phosphate and the pea starch.

[12] The method for producing a food according to [10] or [11], in which the food is one selected from the group consisting of a processed meat-like food, a processed meat food, a processed sea food, and a bakery food.

[13] A method for imparting at least one of a binding property, an elasticity, and a deflating reduction function to a food, the method including blending the composition according to any one of [1] to [7].

[14] The method according to [13], in which the composition is blended after being dissolved or dispersed in water.

[15] The method according to [13] or [14], in which the food is one selected from the group consisting of a processed meat-like food, a processed meat food, a processed sea food, and a bakery food.

### Advantageous Effects of Invention

According to the present invention, an egg white substitute can be provided.

### DESCRIPTION OF EMBODIMENTS

Hereinafter, embodiments of the present invention will be described. Unless stated otherwise, the term “to” in a numerical range indicates being equal to or more than a value and equal to or less than another value, both the values at the two ends being included. In addition, in the present embodiment, it is possible for a composition to include each component alone or in a combination of two or more thereof.

(Composition)

In the present embodiment, a composition is a composition containing a polysaccharide thickener and a starch. The polysaccharide thickener is one kind or two or more kinds selected from the group consisting of methyl cellulose, mannan, and curdlan, and the starch is one or two kinds selected from the group consisting of a distarch phosphate and a pea starch.

The composition of the present embodiment has an egg white substitute function. For example, the composition is a composition for imparting at least one of a binding property and an elasticity to a food. In addition, the composition is, for example, a composition for imparting a deflating reduction function to a food.

(Polysaccharide Thickener)

The polysaccharide thickener of the present embodiment is one kind or two or more kinds selected from the group consisting of methyl cellulose, mannan, and curdlan. The polysaccharide thickener is preferably methyl cellulose.

(Methyl Cellulose)

The methyl cellulose is what some of hydrogen atoms of a hydroxyl group in cellulose is substituted with a methoxy group. A degree of substitution of the hydrogen atoms of the hydroxyl group of the methyl cellulose (a ratio of the hydrogen atoms of the hydroxyl group of the cellulose being substituted with the methoxy group) is not limited, and any hydrogen atom may be selected. A content of the methoxy group in the methyl cellulose may be, for example, approximately 15% to 45%.

(Mannan)

Mannan is a polysaccharide composed mainly of mannose. Examples thereof include glucomannan composed of glucose and mannose, galactomannan composed of galactose and mannose, and plant-derived mannan such as Tsukuneimo or Yam. The mannan is preferably konjac root-derived glucomannan.

(Curdlan)

Curdlan is a thermocoagulable polysaccharide mainly composed of a β-1,3-glucoside bond. The curdlan is a thermocoagulable β-1,3-glucan produced by microorganisms belonging to the genus Alcaligenes or Agrobacterium, or microorganisms such as Euglena.

A content of the polysaccharide thickener in the composition is preferably 0.5% by mass or more, more preferably 0.8% by mass or more, even more preferably 1% by mass or more, still more preferably 1.2% by mass or more, and even still more preferably 1.4% by mass or more with respect to the entire composition, from a viewpoint of imparting at least one of the binding property, the elasticity, and the deflating reduction function to a food.

In addition, from the same viewpoint, the content of the polysaccharide thickener in the composition is preferably 5% by mass or less, more preferably 4% by mass or less, even more preferably 3.5% by mass or less, still more preferably 3% by mass or less, and even still more preferably 2.5% by mass or less with respect to the entire composition.

(Starch)

The starch of the present embodiment is one or two kinds selected from the group consisting of a distarch phosphate and a pea starch. The starch preferably contains two kinds of the distarch phosphate and the pea starch.

A content of the starch in the composition is preferably 10% by mass or more, more preferably 30% by mass or more, even more preferably 50% by mass or more, still more preferably 80% by mass or more, even still more preferably 90% by mass or more, and ma be further even still more preferably 95% by mass or more with respect to the entire composition, from a viewpoint of imparting at least one of the binding property, the elasticity, and the deflating reduction function to a food.

In addition, from the same viewpoint, the content of the starch in the composition is preferably 99.5% by mass or less, more preferably 99.2% by mass or less, even more preferably 99% by mass or less, still more preferably 98.8% by mass or less, and even still more preferably 98.5% by mass or less with respect to the entire composition.

The content of the starch in the composition is preferably 10 or more, more preferably 30 or more, even more preferably 40 or more, still more preferably 50 or more, and even still more preferably 60 or more in terms of a mass ratio to the polysaccharide thickener, from a viewpoint of imparting at least one of the binding property, the elasticity, and the deflating reduction function to a food.

In addition, from the same viewpoint, the content of the starch in the composition is preferably 200 or less, more preferably 150 or less, even more preferably 120 or less, still more preferably 100 or less, and even still more preferably 85 or less in terms of a mass ratio to the polysaccharide thickener.

(Distarch Phosphate)

The distarch phosphate is obtainable by performing a phosphate crosslinking treatment on a raw material starch. The raw material starch is not limited, examples thereof include a cornstarch such as a cornstarch, a waxy cornstarch, or a high-amylose cornstarch, a tapioca starch, a sweet potato starch, a potato starch, a wheat starch, a high-amylose wheat starch, a rice starch, a bean starch, and the like, and these can be used alone or in combination of two or more kinds thereof. The raw material starch is preferably one kind or two or more kinds selected from a tapioca starch, a wheat starch, a cornstarch, and a potato starch, and more preferably one or two kinds selected from a tapioca starch and a wheat starch.

Phosphate crosslinking can be performed by a conventional method. A commercially available product can also be used as a distarch phosphate. Further, in addition to the phosphate crosslinking treatment, the starch may be subjected to other chemical treatments, physical treatments, enzymatic treatments, and the like. Examples of the chemical treatments include an acid treatment, an alkali treatment, an oxidation treatment, an esterification treatment such as acetylation, etherification treatment such as hydroxypropylation, and the like and examples of the physical treatments may include an oil or fat-processing treatment, a heat treatment, a gelatinization treatment, a wet heat treatment, a ball mill treatment, a fine pulverization treatment, and the like. Such treatments may be performed alone or in combination of two or more kinds thereof.

The content of the distarch phosphate in the composition is preferably 2 or more, more preferably 5 or more, even more preferably 10 or more, still more preferably 15 or more, and even still more preferably 20 or more in terms of a mass ratio to the polysaccharide thickener, from a viewpoint of imparting at least one of the binding property, the elasticity, and the deflating reduction function to a food.

In addition, from the same viewpoint, the content of the distarch phosphate in the composition is preferably 150 or less, more preferably 100 or less, even more preferably 80 or less, still more preferably 65 or less, and even still more preferably 50 or less in terms of a mass ratio to the polysaccharide thickener.

(Pea Starch)

The pea starch means a starch contained in the grain of peas at approximately 50%. Pea (Pisum sativum L.) is an annual or biennial herb belonging to the legume family, and is widely used as a food, regardless of the type. The starch is a natural polymer in which α-glucose molecules are polymerized through glycoside bonds, and is composed of amylose having a linear molecular structure and amylopectin having a branched structure. A content (a mass ratio) of amylose with respect to a total amount of pea starch is approximately 20% or more and 40% or less.

A method for producing the pea starch is not limited, as long as it is produced according to the conventional method using peas as a raw material. In general, the pea starch is obtainable by washing and drying the grain of the ripened peas, which is a raw material, removing an outer shell, and removing proteins, salts, dietary fibers, and the like mainly using water. The pea starch used in the present embodiment is preferably dried and powdered. In addition, the pea starch may be unprocessed (a raw starch) or may be a processed starch processed by a known method such as a chemical, physical or enzymatic method. The pea starch is preferably one or two kinds selected from an unprocessed pea starch and an oil or fat-processed pea starch.

The content of the pea starch in the composition is preferably 2 or more, more preferably 10 or more, even more preferably 20 or more, still more preferably 30 or more, and even still more preferably 40 or more in terms of a mass ratio to the polysaccharide thickener, from a viewpoint of imparting at least one of the binding property, the elasticity, and the deflating reduction function to a food.

In addition, from the same viewpoint, the content of the pea starch in the composition is preferably 150 or less, more preferably 120 or less, even more preferably 100 or less, still more preferably 80 or less, and even still more preferably 70 or less in terms of a mass ratio to the polysaccharide thickener.

The content of the pea starch in the composition is preferably 0.1 or more, more preferably 0.5 or more, even more preferably 1 or more, still more preferably 1.5 or more, and even still more preferably 2 or more in terms of a mass ratio to the distarch phosphate, from a viewpoint of imparting at least one of the binding property, the elasticity, and the deflating reduction function to a food.

In addition, from the same viewpoint, the content of the pea starch in the composition is preferably 20 or less, more preferably 15 or less, even more preferably 10 or less, still more preferably 8 or less, and even still more preferably 6 or less in terms of a mass ratio to the distarch phosphate.

Since the composition of the present embodiment has an egg white substitute function, the composition can be suitably used as an egg white substitute. For example, according to the present embodiment, it is possible to provide an egg white substitute capable of imparting excellent egg white-like binding property and elasticity to a food. In addition, according to the present embodiment, for example, it is possible to provide a composition capable of imparting an egg white-like deflating reduction function to a food.

(Food)

The composition obtainable in the present embodiment can be appropriately used in a food. Specific examples of the food include a processed meat food, a processed meat-like food, a processed sea food, a bakery food, a chilled dessert, noodles, a processed egg-like food, and the like. The food preferably includes a processed meat-like food, a processed meat food, and a processed sea food. In addition, a preferred food additionally includes a bakery food.

(Processed Meat Food and Processed Meat-Like Food)

The composition obtainable in the present embodiment is suitably used for, for example, a processed meat food, or a processed meat-like food obtainable by substituting the meat in a processed meat food with a plant protein.

Specific examples of the processed meat food or the processed meat-like food include nuggets such as chicken nuggets; meat pastes such as hamburg steaks, meatballs, sausages, shumai, or dumplings, meat fillings such as meat buns or Chinese buns, and the like. The processed meat food or the processed meat-like food is preferably selected from the group consisting of hamburg steaks, sausages, and nuggets.

The meat in the processed meat food may be specifically at least one kind selected from the group consisting of meat of mammals such as cows, pigs, sheep and goats; and meat of birds typified by poultry such as chickens, domestic ducks, turkeys, geese, and wild ducks. The meat in the processed meat food is preferably at least one kind selected from the group consisting of chicken, pork, and beef. In addition, the meat is preferably in the form of minced meat or in the form of paste, such as minced meat or surimi.

(Processed Sea Food)

The composition obtainable in the present embodiment is appropriately used in a processed sea food. Specific examples of processed sea food include fish paste products such as tsumire, Kamaboko, fish sausage, and hanpen; grilled fish, shrimp cutlet, fried shrimp, fried fish, and the like. The processed sea food is preferably selected from the group consisting of fish paste products such as kamaboko, tsumire, hanpen, fish sausage, and the like.

Specific examples of the sea food, that is a target in the processed sea food include fishes such as tuna, mamakari (Japanese sardinella), tara (pollock), hairtail, eso (lizardfish), sardines, saury, mackerel, eel, salmon, horse mackerel, conger eel, monkfish, bonito, Spanish mackerel, herring, yellowtail, cod, sea bream, scorpionfish, southern cod, shiroganedara (Merluccius productus), kintokidai (Priacanthus macracanthus), alfonsino, itoyoridai (Threadfin bream) Atka mackerel, blue shark, hammerhead shark, mako shark, akauo (Pacific ocean perch), Yellowfin sole, aburagarei (Kamchatka flounder), shiroguchi (white croaker), renkodai (deep-sea porgy), kurokajiki (black marlin), konoshiro (gizzard shad), and the like; shellfish such as scallops; cephalopod such as squid, octopus, and the like. In addition, the form of the sea food is preferably in the form of minced meat or in the form of paste, such as minced meat or surimi.

(Bakery Food)

Specific examples of the bakery food include baked confectioneries such as financiers, cake donuts, yeast donuts, scones, pound cakes, sponge cakes, chiffon cakes, rolled cakes, butter cakes, muffins, cupcakes, hotcakes, bosse, waffles, madeleines, pies, and cookies; bread, pizza, Chinese steamed bun, naan, and Danish pastry, and the like. The bakery food is preferably the baked confectioneries and more preferably financiers.

The food may be suitably blended with seasonings, spices, flavors, preservatives, acidulants, thickeners, gelling agents, antioxidants, or the like, and vegetable ingredients such as onions, carrots, bell peppers, cabbages, or the like.

A content of the composition in the food is preferably 0.5% by mass or more, more preferably 1% by mass or more, even more preferably 1.5% by mass or more, still more preferably 2% by mass or more, and even still more preferably 3% by mass or more with respect to the entire food, from a viewpoint of imparting at least one of the binding property, the elasticity, and the deflating reduction function to a food.

In addition, from the same viewpoint, the content of the composition in the food is preferably 50% by mass or less, more preferably 30% by mass or less, even more preferably 20% by mass or less, still more preferably 15% by mass or less, and even still more preferably 10% by mass or less with respect to the entire food.

(Method for Producing Food)

A method for producing a food includes, for example, obtaining an aqueous solution or a dispersion by dissolving or dispersing a polysaccharide thickener and a starch in water, and obtaining a food by preparing a material containing the aqueous solution or the dispersion. The polysaccharide thickener is one kind or two or more kinds selected from the group consisting of methyl cellulose, mannan, and curdlan, and the starch is one or two kinds selected from the group consisting of a distarch phosphate and a pea starch.

In the obtaining an aqueous solution or a dispersion by dissolving or dispersing the polysaccharide thickener and the starch in water, a content of water in the aqueous solution or the dispersion is preferably 0.1 or more, more preferably 0.5 or more, even more preferably 1 or more, still more preferably 2 or more, and even still more preferably 2.5 or more, in terms of a mass ratio to a total mass of the polysaccharide thickener and the starch.

In addition, the content of water in the aqueous solution or the dispersion is preferably 15 or less, more preferably 10 or less, even more preferably 8 or less, still more preferably 5 or less, and even still more preferably 4 or less, in terms of a mass ratio to the total mass of the polysaccharide thickener and the starch.

A content of the aqueous solution or the dispersion, in which the polysaccharide thickener and the starch are dissolved or dispersed in water, in the food is preferably 1% by mass or more, more preferably 2% by mass or more, even more preferably 3% by mass or more, still more preferably 5% by mass or more, and even still more preferably 8% by mass or more with respect to the entire food.

In addition, the content of the aqueous solution or the dispersion, in which the polysaccharide thickener and the starch are dissolved or dispersed in water, in the food is preferably 70% by mass or less, more preferably 50% by mass or less, even more preferably 40% by mass or less, still more preferably 30% by mass or less, and even still more preferably 25% by mass or less with respect to the entire food.

The obtaining a food preferably includes cooking by heating, from the viewpoints of a bactericidal effect on the food and enhancement of storage stability. Specific examples of cooking by heating include cooking by heating in an oven or the like; cooking by microwave heating; cooking by heating in a steam convection oven or the like; cooking by heating on a thinly oiled frying pan or an iron plate; and deep-frying in edible oils or fats at approximately 100° C. to 200° C., and from the same viewpoint, cooking by heating in an oven or the like or cooking by heating on a frying pan or an iron plate is preferable.

(Method for Imparting at Least One of Binding Property, Elasticity, and Deflating Reduction Function to Food)

The present embodiment provides a method for imparting at least one of a binding property, an elasticity, and a deflating reduction function to a food by using the composition described above. Such a method specifically includes blending the composition described above, and preferably includes blending after dissolving or dispersing the composition in water.

By using the composition described above, for example, it is possible to impart egg white-like binding property and elasticity to the food. In addition, excellent hardness can also be imparted to the food. In the present embodiment, the binding property refers to a property of binding food materials together, maintaining a shape of a food, and improving a texture of a food, and the elasticity refers to a property that, when a pressure is applied to a food, a force to repel it is generated.

In addition, by using the composition described above, for example, it is possible to impart egg white-like deflating reduction function to the food. Here, the deflating reduction function is a function of reducing occurrence of recesses due to contraction of dough after baking that has expanded during baking of a bakery food.

The present invention includes the following aspects.

1. A composition for imparting at least one of a binding property and an elasticity to a food, the composition including a polysaccharide thickener, and a starch,
in which the polysaccharide thickener is one or two or more kinds selected from the group consisting of methyl cellulose, mannan, and curdlan, and
the starch is one or two kinds selected from the group consisting of a distarch phosphate and a pea starch.

2. The composition according to 1., in which the starch includes two kinds of a distarch phosphate and a pea starch.

3. The composition according to 1. or 2., in which a content of the starch is 10 or more and 200 or less in terms of a mass ratio to the polysaccharide thickener.

4. The composition according to any one of 1. to 3., in which a content of the distarch phosphate is 2 or more and 150 or less in terms of a mass ratio to the polysaccharide thickener.

5. The composition according to any one of 1. to 4., in which a content of the pea starch is 2 or more and 150 or less in terms of a mass ratio to the polysaccharide thickener.

6. A food including the composition according to any one of 1. to 5.

7. The food according to 6., in which the food is one kind or two or more kinds selected from the group consisting of a processed meat-like food, a processed meat food, and a processed sea food.

8. A method for producing a food, the method including:
obtaining an aqueous solution by dissolving a polysaccharide thickener and a starch in water; and
obtaining a food by preparing a material containing the aqueous solution,
in which the polysaccharide thickener is one kind or two or more kinds selected from the group consisting of methyl cellulose, mannan, and curdlan, and
the starch is one or two kinds selected from the group consisting of a distarch phosphate and a pea starch.

9. The method for producing a food according to 8., in which the starch includes two kinds of a distarch phosphate and a pea starch.

10. The method for producing a food according to 8. or 9., in which the food is one kind or two or more kinds selected from the group consisting of a processed meat-like food, a processed meat food, and a processed sea food.

11. A method for imparting at least one of a binding property or an elasticity to a food, in which the composition according to any one of 1. to 5. is used.

12. The method according to 11., in which the composition is used after dissolving in water.

13. The method according to 11. or 12., in which the food is one kind or two or more kinds selected from the group consisting of a processed meat-like food, a processed meat food, and a processed sea food.

### EXAMPLES

Hereinafter, the present invention will be described in more detail with reference to examples, but the present invention is not limited thereto.

The raw materials below were mainly used as the raw materials.

1. Raw Materials for Producing Composition

(Polysaccharide thickener)
Methyl cellulose: Heatgel Cho, manufactured by Unitec Foods Co., Ltd. (a methoxy group of 25% to 33%, a melting temperature of 10° C. or lower)
Mannan (glucomannan): Ultramannan, manufactured by Ina Food Industry Co., Ltd.
Curdlan: Curdlan CD-ES, manufactured by Organo Food Tech Co., Ltd.
Hydroxypropyl methyl cellulose A: Heatsol Yurumi L, manufactured by Unitec Foods Co., Ltd.
Hydroxypropyl methyl cellulose B: Heatsol Yurumi, manufactured by Unitec Foods Co., Ltd.
Hydroxypropyl methyl cellulose C: Heatsol Yurumi MH, manufactured by Unitec Foods Co., Ltd.

(Distarch Phosphate)
Distarch phosphate from tapioca starch A: ACTBODY TP-1, manufactured by J-Oil Mills, Inc.
Distarch phosphate from tapioca starch B: ACTBODY TP-4W, manufactured by J-Oil Mills, Inc.
Acetylated distarch phosphate from tapioca starch: ACTBODY ATP-27, manufactured by J-Oil Mills, Inc.
Distarch phosphate from wheat starch: Gelcol WP, manufactured by J-Oil Mills, Inc.

(Pea Starch)
Unprocessed pea starch: PURIS Pea Starch PS85-B, manufactured by Puris
Oil or fat-processed pea starch: a product produced by adding and mixing 0.2% of a safflower oil (a safflower salad oil, manufactured by Summit Oil Co., Ltd.) to and with an unprocessed pea starch (PURIS Pea Starch PS85-B, manufactured by Puris), and heating a resultant product in a thermostatic chamber (70° C.) for 21 days

(Other Starches)
Cornstarch: Cornstarch Y, manufactured by J-Oil Mills, Inc.
Gelatinized cornstarch: Alpha Waxy Starch Y, manufactured by J-Oil Mills, Inc.

2. Other Raw Materials
Dry egg white powder: Dry egg white K Type No. 10, manufactured by Kewpie Egg Corporation
Granular soybean protein material A: FUJINIK ACE 400, manufactured by FUJI OIL CO., LTD.
Granular soybean protein material B: FUJINIK ACE 500, manufactured by FUJI OIL CO., LTD.
Granular soybean protein material C: VEGITEX SHF, manufactured by FUJI OIL CO., LTD.
Granular soybean protein material D: Apex 950, manufactured by FUJI OIL CO., LTD.
Soybean protein: ProFam 974, manufactured by ADM Japan Ltd.
Umami seasoning: AJINOMOTO, manufactured by Ajinomoto Co., Inc.
Beetroot powder: Beetroot powder, manufactured by Maruha Bussan Co., Ltd.
Caramel pigment: caramel, manufactured by Kosei Co., Ltd.
Sauteed onion: Onion saute, manufactured by Kobe Bussan Co., Ltd.
Solid fat: Euromelt 20B, manufactured by J-Oil Mills, Inc.
Cylindrical fat: product produced by the same producing method as an oil or fat composition 13 disclosed in Pamphlet of International Publication No. WO2020/004058
Bread crumbs: Soft bread crumbs, manufactured by Nisshin Foods Co., Ltd.
Alaska pollock surimi: Surimi grade KA
Potato starch: Gelcol BP-200, manufactured by J-Oil Mills, Inc.
Rapeseed oil: AJINOMOTO Sarasara Canola Oil, manufactured by J-Oil Mills, Inc.
Instant bouillon: Instant bouillon, manufactured by Yamaki Co., Ltd.
Margarine: Violife biobutter, manufactured by J-Oil Mills, Inc.
Powdered sugar: powdered sugar, manufactured by Uehara Co., Ltd.
Liquid sugar: Nitto High Sweet, manufactured by Dai-Nippon Meiji Sugar Co., Ltd.
Soft flour: HEART, manufactured by NIPPN CORPORATION
Strong flour: EAGLE, manufactured by NIPPN CORPORATION
Almond powder: Almond powder, manufactured by Iwase Esta Group Headquarters Co., Ltd.
Baking powder: F-up, manufactured by Aikoku Co., Ltd.
Vanilla oil: Vanilla flavor No. 54305, manufactured by Golden Kelly Pat. Flavor Co., Ltd.

### Example 1

With the blending shown in Table 1, compositions of Control Examples 1-1 to 1-4, Comparative Examples 1-5 to 1-7, and Examples 1-1 and 1-2 and evaluation samples using these were produced by the method described below.

1. A composition was obtained by mixing blending raw materials except for water.

2. Water was added to the composition obtained in the part 1. and mixed and stirred using a TK homomixer (TK homomixer, manufactured by Tokushu Kika Kogyo Co., Ltd.).

3. After deaeration, 120 g each was filled in a film casing.

4. A resultant material of the part 3. was heated in hot water at 90° C. for 80 minutes and then water-cooled for 60 minutes.

5. A resultant material of the part 4. was allowed to stand at room temperature of 20° C. overnight as in the casing.

6. The film casing was peeled off and a resultant material was cut to have a width of 20 mm, and five evaluation samples were produced for each of control examples, comparative examples, and examples.

The evaluation samples were evaluated for the binding property, hardness, and elasticity. A breaking strength and a breaking strain rate of each sample were measured using a texture analyzer (TA-XT Plus, manufactured by Stable Micro Systems). A needle type plunger was used, and the measurement was performed under a condition of a penetration speed of 1 mm/sec. In each of control examples, comparative examples and examples, an average value of the five samples was used as an evaluation value, and the evaluation was performed according to the following criteria. The evaluation results are shown in Table 1.

(Breaking Strength (g))

A breaking strength is regarded as an index of a binding property and hardness. In a case where the breaking strength is equivalent to 80% of a measurement result of blending of 12.5% of dry egg white powder in Control Example 1-1, a sufficient function can be exhibited when added to a food. Therefore, a sample, in which the breaking strength of 372 g or more, that is equivalent to 80%, was determined to have a binding property and hardness equivalent to or higher than those of the dry egg white powder, and considered as acceptable.

(Breaking Strain Rate (%))

A breaking strain rate is regarded as an index of elasticity. In a case where the breaking strain rate is equivalent to 80% of a measurement result of blending of 12.5% of dry egg white powder in Control Example 1-1, a sufficient function can be exhibited when added to a food. Therefore, a sample, in which the breaking strain rate of 47.3% or more, that is equivalent to 80%, was determined to have elasticity equivalent to or higher than those of the dry egg white powder, and considered as acceptable.

TABLE 1

| | | Control | Control | Control | Control | Comparative | Comparative | Comparative | | |
|---|---|---|---|---|---|---|---|---|---|---|
| | | Example | Example | Example | Example | Example | Example | Example | Example | Example |
| | | 1-1 | 1-2 | 1-3 | 1-4 | 1-5 | 1-6 | 1-7 | 1-1 | 1-2 |
| Blending | Dry egg white | 12.5% | 15.0% | 17.5% | 20.0% | | | | | |
| (% by mass) | powder | | | | | | | | | |
| | Methyl cellulose | | | | | | | | 0.3% | 0.3% |
| | Cornstarch | | | | | 20.0% | | | | |
| | Distarch | | | | | | | | 25.0% | |
| | phosphate from | | | | | | | | | |
| | wheat starch | | | | | | | | | |
| | Unprocessed pea | | | | | | 20.0% | | | 20.0% |
| | starch | | | | | | | | | |
| | Oil or fat- | | | | | | | 20.0% | | |
| | processed pea | | | | | | | | | |
| | starch | | | | | | | | | |
| | Water | 80.0% | 80.0% | 80.0% | 80.0% | 80.0% | 80.0% | 80.0% | 74.8% | 79.7% |
| | Total | 100.0% | 100.0% | 100.0% | 100.0% | 100.0% | 100.0% | 100.0% | 100.0% | 100.0% |
| Evaluation | Breaking | 465.1 | 757.4 | 1126.0 | 1628.0 | 170.0 | 838.5 | 1109.4 | 632.1 | 585.9 |
| | strength (g) | | | | | | | | | |
| | Breaking strain | 59.1% | 59.1% | 63.3% | 62.5% | 35.0% | 24.2% | 22.5% | 56.5% | 49.8% |
| | rate (%) | | | | | | | | | |

As a result, as shown in Table 1, in Example 1-1 in which the polysaccharide thickener and the distarch phosphate were used and Example 1-2 in which the polysaccharide thickener and the pea starch were used, a composition having excellent binding property, hardness, and elasticity, that are equivalent to or higher than those of Control Example 1-1, in which the dry egg white powder was used, could be obtained. In contrast, in Comparative Examples 1-5 to 1-7 not containing the polysaccharide thickener, a composition having excellent binding property, hardness, and elasticity, could not be obtained.

### Example 2

With the blending shown in Tables 2 and 3, compositions and evaluation samples of Examples 2-1 to 2-8 were produced by the same method as in Example 1.

The evaluation samples were evaluated for the binding property, hardness, and elasticity according to the same criteria as in Example 1. The evaluation results are shown in Tables 2 and 3.

TABLE 2

| | | Example 2-1 | Example 2-2 | Example 2-3 | Example 2-4 | Example 2-5 |
|---|---|---|---|---|---|---|
| Blending | Methyl cellulose | 0.3% | 0.3% | 0.3% | 0.3% | 0.3% |
| (% by mass) | Mannan | | | | | |
| | Curdlan | | | | | |
| | Distarch phosphate from tapioca | 5.0% | | | | |
| | starch A | | | | | |
| | Distarch phosphate from tapioca | | 5.0% | | | 5.0% |
| | starch B | | | | | |
| | Acetylated distarch phosphate | | | 5.0% | | |
| | from tapioca starch | | | | | |
| | Distarch phosphate from wheat | | | | 5.0% | |
| | starch | | | | | |
| | Unprocessed pea starch | 20.0% | 20.0% | 20.0% | 20.0% | |
| | Oil or fat-processed pea starch | | | | | 20.0% |
| | Water | 74.7% | 74.7% | 74.7% | 74.7% | 74.7% |
| | Total | 100.0% | 100.0% | 100.0% | 100.0% | 100.0% |
| Evaluation | Breaking strength (g) | 586.0 | 843.9 | 588.3 | 1090.6 | 980.1 |
| | Breaking strain rate (%) | 53.9% | 53.3% | 53.6% | 52.9% | 50.1% |

TABLE 3

| | | Example 2-6 | Example 2-7 | Example 2-8 |
|---|---|---|---|---|
| Blending | Methyl cellulose | 0.3% | | |
| (% by mass) | Mannan | | 0.3% | |
| | Curdlan | | | 0.3% |
| | Distarch phosphate from | | | |
| | tapioca starch A | | | |
| | Distarch phosphate from | 3.0% | 3.0% | 3.0% |
| | tapioca starch B | | | |
| | Acetylated distarch phosphate | | | |
| | from tapioca starch | | | |
| | Distarch phosphate from wheat | | | |
| | starch | | | |
| | Unprocessed pea starch | 17.0% | 17.0% | 17.0% |
| | Oil or fat-processed pea starch | | | |
| | Water | 79.7% | 79.78 | 79.7% |
| | Total | 100.0% | 100.08 | 100.0% |
| Evaluation | Breaking strength (g) | 628.7 | 592.9 | 584.2 |
| | Breaking strain rate (%) | 54.0% | 56.2% | 50.8% |

As a result, as shown in Tables 2 and 3, in all of the examples, the binding property, the hardness, and the elasticity were excellent. Among them, in Table 2, Examples 2-2 and 2-5 in which distarch phosphate from tapioca starch B was used for the distarch phosphate, and Example 2-4 in which distarch phosphate from wheat starch was used showed more excellent properties. In addition, in Table 3, Example 2-6 in which methyl cellulose was used for the polysaccharide thickener and Example 2-7 in which mannan was used showed more excellent properties.

### Example 3

With the blending shown in Tables 4 and 5, compositions and evaluation samples of Examples 3-1 to 3-5 were produced by the same method as in Example 1.

The evaluation samples were evaluated for the binding property, hardness, and elasticity according to the same criteria as in Example 1. The evaluation results are shown in Tables 4 and 5. Table 4 shows Example 1-1 again and Table 5 shows Example 2-2 and 2-6 again.

TABLE 4

| | | Example 1-1 | Example 3-1 |
|---|---|---|---|
| Blending | Methyl cellulose | 0.3% | 0.5% |
| (% by mass) | Distarch phosphate from wheat | 25.0% | 25.0% |
| | starch | | |
| | Water | 74.8% | 74.5% |
| | Total | 100.0% | 100.0% |
| Evaluation | Breaking strength (g) | 632.1 | 518.1 |
| | Breaking strain rate (%) | 56.5% | 56.2% |

TABLE 5

| | | Example | Example | Example | Example | Example | Example |
|---|---|---|---|---|---|---|---|
| | | 2-2 | 3-2 | 3-3 | 2-6 | 3-4 | 3-5 |
| Blending | Methyl cellulose | 0.3% | 0.5% | 0.2% | 0.3% | 0.4% | 0.5% |
| (% by mass) | Distarch phosphate from | 5.0% | 5.0% | 3.0% | 3.0% | 3.0% | 3.0% |
| | tapioca starch B | | | | | | |
| | Unprocessed pea starch | 20.0% | 20.0% | 17.0% | 17.0% | 17.0% | 17.0% |
| | Water | 74.7% | 74.5% | 79.8% | 79.7% | 79.6% | 79.5% |
| | Total | 100.0% | 100.0% | 100.0% | 100.0% | 100.0% | 100.0% |
| Evaluation | Breaking strength (g) | 843.9 | 666.1 | 640.3 | 628.7 | 495.5 | 496.2 |
| | Breaking strain rate (%) | 53.3% | 54.2% | 51.0% | 54.0% | 55.4% | 49.0% |

As a result, as shown in Tables 4 and 5, in all of the examples, the binding property, the hardness, and the elasticity were excellent.

### Example 4

With the blending shown in Table 6, compositions and evaluation samples of Examples 4-1 to 4-4 were produced by the same method as in Example 1.

The evaluation samples were evaluated for the binding property, hardness, and elasticity according to the same criteria as in Example 1. The evaluation results are shown in Table 6. Table 6 shows Examples 1-2 again.

TABLE 6

| | | Example | Example | Example | Example | Example |
|---|---|---|---|---|---|---|
| | | 4-1 | 4-2 | 4-3 | 4-4 | 1-2 |
| Blending | Methyl cellulose | 0.3% | 0.3% | 0.3% | 0.3% | 0.3% |
| (% by mass) | Distarch phosphate from | 11.0% | 8.0% | 6.0% | 3.0% | |
| | wheat starch | | | | | |
| | Unprocessed pea starch | 9.0% | 12.0% | 14.0% | 17.0% | 20.0% |
| | Water | 79.7% | 79.7% | 79.7% | 79.7% | 79.7% |
| | Total | 100.0% | 100.0% | 100.0% | 100.0% | 100.0% |
| Evaluation | Breaking strength (g) | 421.5 | 500.1 | 587.1 | 597.1 | 585.9 |
| | Breaking strain rate (%) | 54.1% | 54.1% | 55.4% | 56.4% | 49.8% |

As a result, as shown in Table 6, in all of the examples, the binding property, the hardness, and the elasticity were excellent. Among them, Examples 4-3 and 4-4 showed a more excellent content ratio of the distarch phosphate and the pea starch.

### Example 5

Assuming that the composition is used in a processed meat-like food, with the blending shown in Table 7, compositions and evaluation samples assuming a processed meat-like food using the compositions (hereinafter, also simply referred to as “evaluation samples”) of Control Example 5-1, Comparative Example 5-2, and Examples 5-1 to 5-5 were produced by the following method.

### Control Example 5-1, Comparative Example 5-2, and Examples 5-1 to 5-3 and 5-5

1. A granular soybean protein material was rehydrated with water in an amount three times a mass ratio. The amount of granular soybean protein material A in Table 7 is the amount of the rehydrated material.
2. Blending raw materials except for water and the granular soybean protein material were mixed and a composition of each example was obtained.
3. The composition obtained in the part 2. was added to water and mixed and stirred using a hand mixer.
4. A resultant material of the part 3. was added to and mixed with the rehydrated granular soybean protein material of the part 1.
5. 120 g each of a resultant material of the part 4. was filled in a film casing.
6. A resultant material of the part 5. was heated in hot water at 90° C. for 60 minutes and then cooled.
7. After the cooling, the film casing was peeled off and a resultant material was cut to have a width of 20 mm, and evaluation samples were produced.

### Example 5-4

An evaluation sample was produced by the same method as described above except that water and the composition were added as they were to the rehydrated granular soybean protein material without performing the above described part 3.

The produced evaluation samples were evaluated for the binding property, hardness, and elasticity. Three specialized panelists performed the evaluation on a five-point scale according to the following criteria, an average point was regarded as a score, and the score of equal to or higher than 3 points was considered acceptable. The evaluation results are shown in Table 7. In Example 5-5, only the binding property was evaluated.

(Binding Property)
5 points: Having a considerable binding power
4 points: Having a binding power
3 points: Having a slight binding power
2 points: Almost no binding power and crumbling.
1 point: A sample is not bound.

(Hardness)
5 points: Having considerable hardness
4 points: Having hardness
3 points: Having slight hardness
2 points: Having almost no hardness
1 point: Having no hardness

(Elasticity)
5 points: Having a considerable elasticity
4 points: Having an elasticity
3 points: Having a slight elasticity
2 points: Having almost no elasticity
1 point: Having no elasticity

TABLE 7

| | | Control | Comparative | Example | Example | Example | Example | Example |
|---|---|---|---|---|---|---|---|---|
| | | Example 5-1 | Example 5-2 | 5-1 | 5-2 | 5-3 | 5-4 | 5-5 |
| Blending | Granular soybean | 60.00% | 60.00% | 60.00% | 60.00% | 60.00% | 60.00% | 60.00% |
| (% by mass) | protein material A | | | | | | | |
| | Dry egg white powder | 10.00% | | | | | | |
| | Methyl cellulose | | 0.15% | 0.15% | 0.15% | | 0.15% | 0.15% |
| | Mannan | | | | | 0.15% | | |
| | Gelatinized | | 9.85% | | | | | |
| | cornstarch | | | | | | | |
| | Distarch phosphate | | | | | | | 8.37% |
| | from tapioca starch | | | | | | | |
| | B | | | | | | | |
| | Distarch phosphate | | | 9.85% | 1.48% | 1.48% | 1.48% | 1.48% |
| | from wheat starch | | | | | | | |
| | Unprocessed pea | | | | 8.37% | 8.37% | 8.37% | |
| | starch | | | | | | | |
| | Water | 30.00% | 30.00% | 30.00% | 30.00% | 30.00% | 30.00% | 30.00% |
| | Total | 100.00% | 100.00% | 100.00% | 100.00% | 100.00% | 100.00% | 100.00% |
| Evaluation | Binding property | 5.0 | 1.0 | 3.5 | 5.0 | 5.0 | 2.6 | 5.0 |
| | Hardness | 5.0 | 1.0 | 4.1 | 4.1 | 4.0 | 4.0 | — |
| | Elasticity | 5.0 | 1.0 | 4.0 | 4.6 | 4.8 | 3.3 | — |

As a result, as shown in Table 7, in Examples 5-1, 5-2, and 5-3, the binding property, the hardness, and the elasticity were excellent. Also in Example 5-5, the binding property was excellent. In contrast, in Comparative Example 5-2 in which gelatinized cornstarch was used, the binding property, the hardness, and the elasticity were not preferable. In addition, in Example 5-2 in which the composition (the starch and the polysaccharide thickener) was dissolved in water and then added to the granular soybean protein material, the binding property and the elasticity were excellent, compared to Example 5-4 in which the composition (the starch and the polysaccharide thickener) was added to the granular soybean protein material as powder. Also in Example 5-4, the elasticity and the hardness were excellent among the egg white substitute function.

### Example 6

With the blending shown in Table 8, soybean hamburg steaks of Control Example 6-1, Comparative Example 6-2, and Example 6 were produced by the following procedure.
1. In the examples, water was added to a mixed powder obtained by mixing methyl cellulose, a distarch phosphate, and a pea starch, and stirred with a hand mixed for approximately 2 minutes, and an aqueous solution was prepared.
2. Each material was weighed, and in the examples, the aqueous solution prepared in the part 1. was added and mixed.
3. 50 g of a resultant material of the part 2. was weighed and a soybean hamburg steak was molded in a cake ring.
4. A resultant material of the part 3. was baked in a steam convection oven (CombiMasterPlusXS, manufactured by RATIONAL) at 200° C. for 8 minutes.

Formability and the binding property of the produced soybean hamburg steaks were evaluated. Three specialized panelists performed the evaluation for the binding property according to the same criteria as in Example 5, and an average point was regarded as a score. Three specialized panelists performed the evaluation for the formability after mixing the materials on a five-point scale according to the following criteria, and an average point was regarded as a score. For each evaluation item, a score of equal to or higher than 3 points was considered acceptable. The evaluation results are shown in Table 8.

(Formability)
5 points: A formability is fairly excellent.
4 points: A formability is excellent.
3 points: A formability is slightly excellent.
2 points: A formability is slightly not excellent.
1 point: A formability is not excellent.

TABLE 8

| | | Control | Comparative | |
|---|---|---|---|---|
| | | Example 6-1 | Example 6-2 | Example 6 |
| Blending | Dry egg white powder | 3.0 | | |
| (parts by mass) | Methyl cellulose | | | 0.1 |
| | Oil or fat-processed pea | | | 4.7 |
| | starch | | | |
| | Distarch phosphate from | | | 1.2 |
| | tapioca starch B | | | |
| | Cold water | 13.0 | 13.0 | 13.0 |
| | Granular soybean protein | 26.0 | 26.0 | 26.0 |
| | material B | | | |
| | Granular soybean protein | 21.0 | 21.0 | 21.0 |
| | material C | | | |
| | Granular soybean protein | 15.0 | 15.0 | 15.0 |
| | material D | | | |
| | Black pepper | 0.2 | 0.2 | 0.2 |
| | Salt | 0.7 | 0.7 | 0.7 |
| | Granulated sugar | 1.0 | 1.0 | 1.0 |
| | Umami seasoning | 1.2 | 1.2 | 1.2 |
| | Beetroot powder | 0.15 | 0.15 | 0.15 |
| | Caramel pigment | 0.25 | 0.25 | 0.25 |
| | Sauteed onion | 10.0 | 10.0 | 10.0 |
| | Solid fat | 8.0 | 8.0 | 8.0 |
| | Cylindrical fat | 3.5 | 3.5 | 3.5 |
| | Total | 103.0 | 100.0 | 106.0 |
| Evaluation | Formability | 3 | 2 | 4 |
| | Binding property | 3 | 1 | 4 |

As a result, as shown in Table 8, in Example 6, a soybean hamburg steak having excellent formability and binding property could be obtained, compared to Control Example 6-1 in which an egg white was used.

### Example 7

With the blending shown in Table 9, hamburg steaks of Control Example 7-1, Comparative Examples 7-2 and 7-3, and Examples 7-1 and 7-2 were produced by the following procedure.
1. In the examples, water was added to a mixed powder obtained by mixing methyl cellulose, a distarch phosphate, and a pea starch, and stirred with a hand mixed for approximately 2 minutes, and an aqueous solution was prepared.
2. Salt was added to minced beef and pork and mixed.
3. Onion, granular soybean protein, and the aqueous solution of the part 1. (for Examples) were mixed and added to a resultant material of the part 2. and mixed.
4. The remaining materials such as bread crumbs, seasonings, and the like were further added to and mixed with a resultant material of the part 3.
5. 60 g of a resultant material of the part 4. was weighed and a hamburg steak was molded in a cake ring.
6. A resultant material of the part 5. was stored frozen in a freezer at −20° C. for 16 hours.
7. A resultant material of the part 6. was put onto a frying pan while it was frozen, and both sides were baked for 1 minute each.
8. A resultant material was baked in a steam convection oven at 200° C. for 7 minutes.

A binding property and baking yield of the produced hamburg steak were evaluated. Six specialized panelists performed the evaluation for the binding property according to the same criteria as in Example 5, and an average point was regarded as a score. A score of equal to or higher than 3.5 was considered acceptable. The baking yield was evaluated by the following method. The evaluation results are shown in Table 9.

(Baking Yield)

A mass of the hamburg steak before baking and a mass of the hamburg steak after baking were measured to determine the baking yield (%). Specifically, the baking yield was calculated using the following equation.

Baking yield (%)=(a mass after baking (g)/a mass before baking (g))×100

TABLE 9

| | | Control | Comparative | Comparative | | |
|---|---|---|---|---|---|---|
| | | Example 7-1 | Example 7-2 | Example 7-3 | Example 7-1 | Example 7-2 |
| Blending | Dry egg white powder | 4.00% | | | | |
| (% by mass) | Methyl cellulose | | | | 0.07% | 0.07% |
| | Unprocessed pea starch | | | | 4.74% | |
| | Oil or fat-processed pea | | | 4.74% | | 4.74% |
| | starch | | | | | |
| | Distarch phosphate from | | | 1.19% | 1.19% | 1.19% |
| | tapioca starch B | | | | | |
| | Cold water | 16.80% | 16.80% | 16.80% | 16.80% | 16.80% |
| | Minced beef and pork | 65.00% | 65.00% | 65.00% | 65.00% | 65.00% |
| | Salt | 0.80% | 0.80% | 0.80% | 0.80% | 0.80% |
| | Onion | 5.00% | 5.00% | 5.00% | 5.00% | 5.00% |
| | Granulated sugar | 1.00% | 1.00% | 1.00% | 1.00% | 1.00% |
| | Bread crumbs | 6.00% | 6.00% | 6.00% | 6.00% | 6.00% |
| | Granular soybean protein | 5.00% | 5.00% | 5.00% | 5.00% | 5.00% |
| | material A | | | | | |
| | Umami seasoning | 0.30% | 0.30% | 0.30% | 0.30% | 0.30% |
| | White pepper | 0.10% | 0.10% | 0.10% | 0.10% | 0.10% |
| | Total | 104.00% | 100.00% | 105.93% | 106.00% | 106.00% |
| Evaluation | Binding property | 3.8 | 3.0 | 3.4 | 3.8 | 3.9 |
| | Baking yield | 84.4% | 72.9% | 87.6% | 91.0% | 91.0% |

As a result, as shown in Table 9, in Examples 7-1 and 7-2, a hamburg steak having a binding property equal to or greater than that of Control Example 7-1, in which an egg white was used, could be obtained. In addition, among the examples shown in Table 9, Examples 7-1 and 7-2 were most excellent in the baking yield.

### Example 8

With the blending shown in Table 10, Kamaboko of Control Example 8-1, Comparative Example 8-2, and Example 8 were produced by the following procedure.
1. Surimi of frozen Alaska pollock was cut and finely pulverized with a food processor (a food processor, manufactured by Cuisinart Corporation).
2. Salt was added to and mixed with a resultant material of the part 1.
3. ⅓ amount of ice was added to and mixed with a resultant material of the part 2.
4. Materials except for salt and ⅓ amount of ice were added to and mixed with a resultant material of the part 3.
5. ⅓ amount of ice was added to and mixed with a resultant material of the part 4.
6. A resultant material of the part 5. was put into a plastic bag with a fastener and degassed with a vacuum packaging machine (Hot Temp, manufactured by Nichiwa Electric Corporation).
7. Vinyl casings were filled with a resultant material of the part 6., and then was pre-heated at 30° C. for 90 minutes.
8. A resultant material of the part 7. was heated in a hot water at 85° C. for 20 minutes.
9. A resultant material of the part 8. was put into ice water and cooled for 10 minutes.

A hardness, elasticity, and crispness of the produced Kamaboko were evaluated. Three specialized panelists performed the evaluation on a five-point scale according to the following criteria, and an average point was regarded as a score. For each evaluation item, a score of equal to or higher than 3 points was considered acceptable. In addition, a freezing-thawing syneresis rate was measured and evaluated by the following method. The evaluation results are shown in Table 10.

(Hardness)
5 points: Harder than Control Example 8-1
4 points: Slightly harder than Control Example 8-1
3 points: Having hardness equivalent to that of Control Example 8-1
2 points: A little softer than Control Example 8-1
1 point: Much softer than Control Example 8-1

(Elasticity and Crispness)
5 points: Stronger elasticity and more excellent crispness than Control Example 8-1
4 points: Slightly stronger elasticity and more excellent crispness than Control Example 8-1
3 points: Having elasticity and crispness equivalent to those of Control Example 8-1
2 points: Slightly less elasticity and slightly poor crispness than Control Example 8-1
1 point: Less elasticity and poor crispness than Control Example 8-1

(Freezing-Thawing Syneresis Rate)
1. A prepared Kamaboko was cut to have a thickness of 15 mm and a weight was measured one by one.
2. The kamaboko was put into a plastic bag with a fastener and frozen in a −20° C. freezer for 15 hours.
3. A resultant material was moved to a refrigerator at 6° C. and allowed to stand for 7 hours to thaw.
4. A resultant material was frozen again in a freezer at −20° C. for 15 hours.
5. A resultant material was moved to a refrigerator at 6° C. and allowed to stand for 5 hours, the thawed Kamaboko was taken out from the bag, and moisture on the surface was lightly wiped off with a paper towel.
6. Each piece was weighed.
7. The freezing-thawing syneresis rate (%) was calculated using the following equation.

Freezing-thawing syneresis rate (%)=((weight before freezing (g)−weight after thawing (g))/weight before freezing (g))×100

In addition, a small value of the freezing-thawing syneresis rate is preferable, because the syneresis amount is small.

TABLE 10

| | | Control | Comparative | |
|---|---|---|---|---|
| | | Example 8-1 | Example 8-2 | Example 8 |
| Blending | Dry egg white powder | 0.50% | | |
| (% by mass) | Methyl cellulose | | | 0.02% |
| | Oil or fat-processed pea starch | | | 1.58% |
| | Distarch phosphate from tapioca | | | 0.40% |
| | starch B | | | |
| | Cold water | | | 4.00% |
| | Alaska pollock surimi | 48.00% | 48.00% | 48.00% |
| | Potato starch | 2.00% | 2.00% | 2.00% |
| | Sugar | 2.00% | 2.00% | 2.00% |
| | Salt | 1.50% | 1.50% | 1.50% |
| | Rapeseed oil | 1.00% | 1.00% | 1.00% |
| | Sake | 1.00% | 1.00% | 1.00% |
| | Instant bouillon | 0.25% | 0.25% | 0.25% |
| | Umami seasoning | 1.00% | 1.00% | 1.00% |
| | Ice | 43.25% | 43.25% | 39.25% |
| | Total | 100.50% | 100.00% | 102.00% |
| Evaluation | Hardness | 3.0 | 2.0 | 3.8 |
| | Elasticity | 3.0 | 2.0 | 3.7 |
| | Freezing-thawing syneresis rate | 14.7% | 13.7% | 8.1% |

As a result, as shown in Table 10, in Example 8, Kamaboko having more excellent hardness, elasticity, and crispness than Control Example 8-1, in which an egg white was used, could be obtained. In addition, in Example 8, the freezing-thawing syneresis rate was excellent, compared to Control Example 8-1 and Comparative Example 8-2.

### Example 9

With the blending shown in Table 11, financiers of Control Example 9-1, Comparative Examples 9-2 to 9-4, and Examples 9-1 to 9-3 were produced by the following procedure.

(Method for Producing Financier)
1. In each example, among the components shown in Table 11, methyl cellulose, an unprocessed pea starch, and a distarch phosphate from tapioca starch B were mixed to obtain a composition.
2. Among the components shown in Table 11, components except for the components used in the part 1., margarine, liquid sugar, water, vanilla oil, and an egg white, and the composition (for each Example) obtained in the part 1. was mixed and sieved.
3. Melted margarine was mixed with a mixture obtained in the part 2., and water, vanilla oil, liquid sugar, and an egg white (for Comparative Example 9-1) were added and mixed well.
4. A dough obtained in the part 3. was filled in a mold and baked in an oven at 180° C. for 20 minutes.

A baked state (deflating) and a powdery state of the financiers obtained in each example were evaluated. Eight specialized panelists performed the evaluation on a five-point scale according to the following criteria, and an average point was regarded as a score. For each evaluation item, a score of equal to or higher than 3 points was considered acceptable. The evaluation results are shown in Table 11.

(Baked State (Deflating))
5 points: No deflating
4 points: Almost no deflating
3 points: Slight deflating, but within the allowable range
2 points: Deflating
1 point: Significant deflating

(Powdery State)
5 points: Not powdery at all
4 points: Almost not powdery
3 points: Slightly powdery but within the allowable range
2 points: Powdery
1 point: Significantly powdery

TABLE 11

| | | Control | Comparative | Comparative | Comparative | Example | Example | Example |
|---|---|---|---|---|---|---|---|---|
| | | Example 9-1 | Example 9-2 | Example 9-3 | Example 9-4 | 9-1 | 9-2 | 9-3 |
| Blending | Margarine | 100.0 | 100.0 | 100.0 | 100.0 | 80.0 | 80.0 | 80.0 |
| (parts by mass) | Powdered sugar | 100.0 | 100.0 | 100.0 | 100.0 | 100.0 | 100.0 | 90.0 |
| | Liquid sugar | | | | | | 10.0 | 10.0 |
| | Methyl cellulose | | | | | 0.24 | 0.24 | 0.24 |
| | Unprocessed pea starch | | | | | 15.80 | 15.80 | 15.80 |
| | Distarch phosphate from | | | | | 3.96 | 3.96 | 3.96 |
| | tapioca starch B | | | | | | | |
| | Soybean protein | | | | | 10.0 | 10.0 | 10.0 |
| | Salt | | | | | 0.3 | 0.3 | 0.3 |
| | Water | | 80.0 | 80.0 | 80.0 | 80.0 | 80.0 | 80.0 |
| | Soft flour | 100.0 | 100.0 | 100.0 | 100.0 | 40.0 | 40.0 | 40.0 |
| | Strong flour | | | | | 40.0 | 40.0 | 40.0 |
| | Almond powder | | | | | 20.0 | 20.0 | 20.0 |
| | Baking powder | 2.0 | 2.0 | 2.0 | 2.0 | 2.0 | 2.0 | 2.0 |
| | Vanilla oil | | | | | 1.0 | 1.0 | 1.0 |
| | Egg white | 100.0 | | | | | | |
| | Hydroxypropyl methyl | | 20.0 | | | | | |
| | cellulose A | | | | | | | |
| | Hydroxypropyl methyl | | | 20.0 | | | | |
| | cellulose B | | | | | | | |
| | Hydroxypropyl methyl | | | | 20.0 | | | |
| | cellulose C | | | | | | | |
| | Total | 402.0 | 402.0 | 402.0 | 402.0 | 393.3 | 403.3 | 393.3 |
| Evaluation | Baked state (deflating) | 5 | 1 | 1 | 1 | 4 | 4 | 4 |
| | Powdery state | 5 | 2 | 2 | 2 | 3 | 3 | 3 |

This application claims priority based on Japanese Patent Application No. 2021-029971 filed on Feb. 26, 2021, the entire disclosure of which is hereby incorporated.

1. A composition having an egg white substitute function, the composition comprising:
a polysaccharide thickener; and
a starch,
wherein the polysaccharide thickener is one kind or two or more kinds selected from the group consisting of methyl cellulose, mannan, and curdlan, and
the starch is one or two kinds selected from the group consisting of a distarch phosphate and a pea starch.

2. The composition according to claim 1,
wherein the composition is a composition for imparting at least one of a binding property and an elasticity to a food.

3. The composition according to claim 1,
wherein the composition is a composition for imparting a deflating reduction function to a food.

4. The composition according to claim 1,
wherein the starch includes the distarch phosphate and the pea starch.

5. The composition according to claim 1,
wherein a content of the starch is 10 or more and 200 or less in terms of a mass ratio to the polysaccharide thickener.

6. The composition according to claim 1,
wherein the starch includes the distarch phosphate, and
a content of the distarch phosphate is 2 or more and 150 or less in terms of a mass ratio to the polysaccharide thickener.

7. The composition according to claim 1,
wherein the starch includes the pea starch, and
a content of the pea starch is 2 or more and 150 or less in terms of a mass ratio to the polysaccharide thickener.

8. A food comprising the composition according to claim 1.

9. The food according to claim 8,
wherein the food is one selected from the group consisting of a processed meat-like food, a processed meat food, a processed sea food, and a bakery food.

10. A method for producing a food, the method comprising:
obtaining an aqueous solution or a dispersion by dissolving or dispersing a polysaccharide thickener and a starch in water; and
obtaining a food by preparing a material containing the aqueous solution or the dispersion,
wherein the polysaccharide thickener is one kind or two or more kinds selected from the group consisting of methyl cellulose, mannan, and curdlan, and
the starch is one or two kinds selected from the group consisting of a distarch phosphate and a pea starch.

11. The method for producing a food according to claim 10,
wherein the starch includes the distarch phosphate and the pea starch.

12. The method for producing a food according to claim 10,
wherein the food is one selected from the group consisting of a processed meat-like food, a processed meat food, a processed sea food, and a bakery food.

13. A method for imparting at least one of a binding property, an elasticity, and a deflating reduction function to a food, the method comprising:
blending the composition according to claim 1.

14. The method according to claim 13,
wherein the composition is blended after being dissolved or dispersed in water.

15. The method according to claim 13,
wherein the food is one selected from the group consisting of a processed meat-like food, a processed meat food, a processed sea food, and a bakery food.
